(19) United States
(12) Patent Application Publication
(10) Pub. No.: US 2011/0037956 A1
(43) Pub. Date: Feb. 17, 2011

(54) LIGHT PIPE AND PROTECTING APPARATUS UTILIZING THE LIGHT PIPE

(76) Inventors: Ming-Kuen Lin, Yun-Lin Hsien (TW); Tsung-Hsun Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/832,937

(22) Filed: Jul. 8, 2010

(30) Foreign Application Priority Data
Aug. 11, 2009 (TW) 098126931

(51) Int. Cl. G03B 21/28; G02B 6/00

(52) U.S. Cl. 353/98; 362/551

(57) ABSTRACT

A light pipe comprises a solid light guiding portion and a hollow light guiding portion. The solid light guiding portion includes a receiving end and an output end, receives a light beam at the receiving end, and transmits the light beam to the output end via total reflection. The hollow light guiding portion includes a hollow output end. The hollow light guiding portion is combined with the output end of the solid light guiding portion in a combination part. The hollow light guiding portion receives the light beam from the output end, and transmits the light beam to the hollow output end via total reflection.

### BACKGROUND OF THE INVENTION

1. Field of the Invention

The present invention relates to a light pipe and a projecting apparatus utilizing the light pipe, and particularly relates to a light pipe with a solid light guiding portion and a hollow light guiding portion, and a projecting apparatus utilizing the light pipe.

2. Description of the Prior Art

FIG. 1 illustrates part of the structures of a prior art projecting apparatus 100. As shown in FIG. 1 the projecting apparatus 100 includes a light source module 101, a light pipe 103, an illumination system 105, an image generator 107 and a projecting lens 109. The light source module 101 always includes a light source and a color wheel to generate light with different color. The light pipe 103 is necessary to transmit light to the illumination system 105 when the light source module 101 is a focusing type light source module such as an ellipsoid light. The light pipe 103 receives the light from the light source module 101 and transmits it to the illumination system 105. The illumination system 105 includes a plurality of lens or reflectors, to transmit light to the image generator such as a Digital Micromirror Device (DMD). The image generator 107 generates an image to the projecting lens 109 according to received light. The projecting lens 109 projects received image to an objective such as a display. Also, the projecting apparatus 100 of FIG. 1 is a secondary imagery projecting apparatus, but not all projecting apparatuses are secondary imagery projecting apparatuses.

The output end area of the light pipe 103 is smaller than which of the image generator 107. However, the imagery amplified by the illumination system 105 is larger than the image processor 107, or a blue fringe problem may be caused. Besides, the light pipe 103 may be implemented by two types of light pipe: solid light pipe and hollow light pipe. Either of these types of light pipes has advantage and disadvantage thereof. In prior art, the hollow light guide is utilized more frequently, since the hollow light guide has lower cost, and has imagery that is not easily affected by the defect of the light pipe or the dust on the light pipe. Normally, reflection material such as silver is provided on the inner side of the light pipe to transmit light. However, the efficiency of such structure decreases when the number of light reflection increases. Also, the inner side of the hollow light pipe may accumulate dust after the hollow light pipe is utilized for many times, such that the efficiency may further decreases. Additionally, the solid light pipe can be made with quartz material, which transmits light via generating total reflection the light in the light pipe. Moreover, the output end of the solid light pipe is easily covered by dust, thus the imagery thereof may affected by the dust. Comparing the hollow light pipe, the solid light pipe has higher cost. Besides, the solid light pipe easily has defect and the imagery thereof may be affected accordingly.

### SUMMARY OF THE INVENTION

Accordingly, one objective of the present invention is to provide a new light pipe, to improve above-mentioned problems. By this way the light pipe can be protected from dust and has good efficiency to transmit light.

One embodiment of the present invention discloses a light pipe comprising a solid light guiding portion and a hollow light guiding portion. The solid light guiding portion includes a receiving end and an output end, receives a light beam at the receiving end, and transmits the light beam to the output end via total reflection. The hollow light guiding portion includes a hollow output end. The hollow light guiding portion is combined with the output end of the solid light guiding portion in a combination part . The hollow light guiding portion receives the light beam from the output end, and transmits the light beam to the hollow output end via total reflection.

Another embodiment of the present invention discloses a projecting apparatus comprising a light source module, a light pipe and an image generator. The light source module generates a light beam. The light pipe comprises a solid light guiding portion and a hollow light guiding portion. The solid light guiding portion includes a receiving end and an output end, receives a light beam at the receiving end, and transmits the light beam to the output end via total reflection. The hollow light guiding portion includes a hollow output end. The hollow light guiding portion is combined with the output end of the solid light guiding portion in a combination part. The hollow light guiding portion receives the light beam from the output end, and transmits the light beam to the hollow output end via total reflection. The image generator receives the light beam from the hollow light guiding portion to generate an image.

According to above mentioned embodiment, since a light incidence direction is toward the solid light guiding portion, dust can be protected from entering the hollow light guiding portion. Besides, a ratio between the hollow light guiding portion and the solid light guiding portion of the present invention can be adjusted. Accordingly, the ratio of the hollow light guiding portion can be increased if less cost is desired, and the ratio of the solid light guiding portion can be increased if higher efficiency is desired.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates part of the structures of a prior art projecting apparatus 100.

FIGS. 2-7 are schematic diagrams respectively illustrates one of the structures for light pipes according to the embodiments of the present invention.

FIGS. 8 and 9 are schematic diagrams illustrating the embodiments that the hollow light guiding portion and the solid guiding portion have the same cross-section areas.

### DETAILED DESCRIPTION

Certain terms are used throughout the description and following claims to refer to particular portions. As one skilled in the art will appreciate, hardware equipment manufacturers may refer to a portion by different names. This document does not intend to distinguish between portions that differ in name but not function. In the following description and in the claims, the terms “include” and “comprise” are used in an open-ended fashion, and thus should be interpreted to mean “include, but not limited to . . . ”.

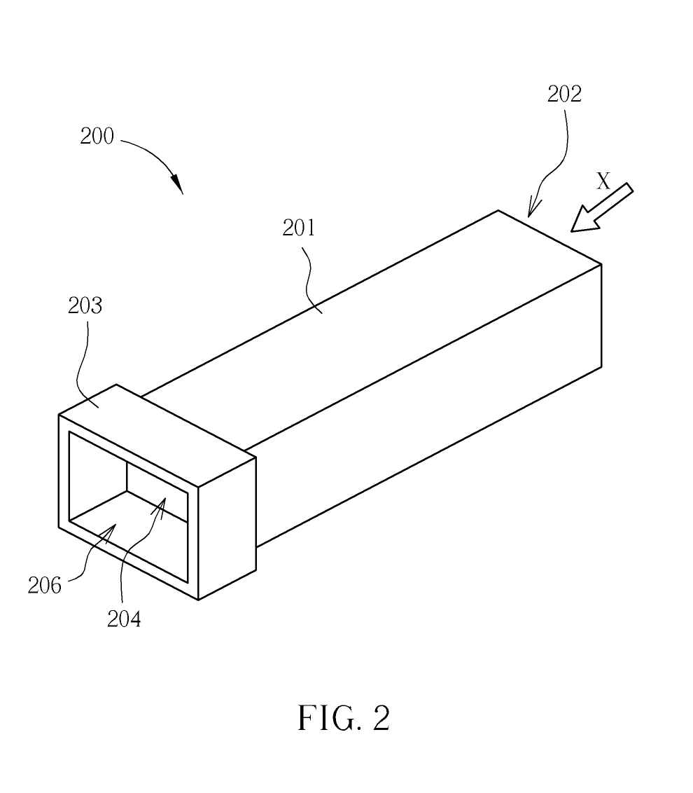

FIGS. 2-7 are schematic diagrams respectively illustrates one of the structures for light pipes according to the embodiments of the present invention. Common features of the embodiments for light pipes shown in FIGS. 2-7 are: the light pipes all include a solid light guiding portion and a hollow light guiding portion; the incidence directions of light all follow an X direction, that is, light all enters the light pipe via an input end thereof; and the light is transmitted via total reflection in both the solid light guiding portion and the hollow light guiding portion. The differences between the embodiments include: the lengths of the solid light guiding portion and the hollow light guiding portion are different, and the solid light guiding portion, the hollow light guiding portion have different cross-section areas at a combination part. Since the dust accumulation problem is more serious for the incidence direction of light, the present invention provides concept that the solid light guiding portion is only provided for the light incidence direction, and no solid light guiding portion is provided for the output end of the light pipe. By this way, the cost can decrease.

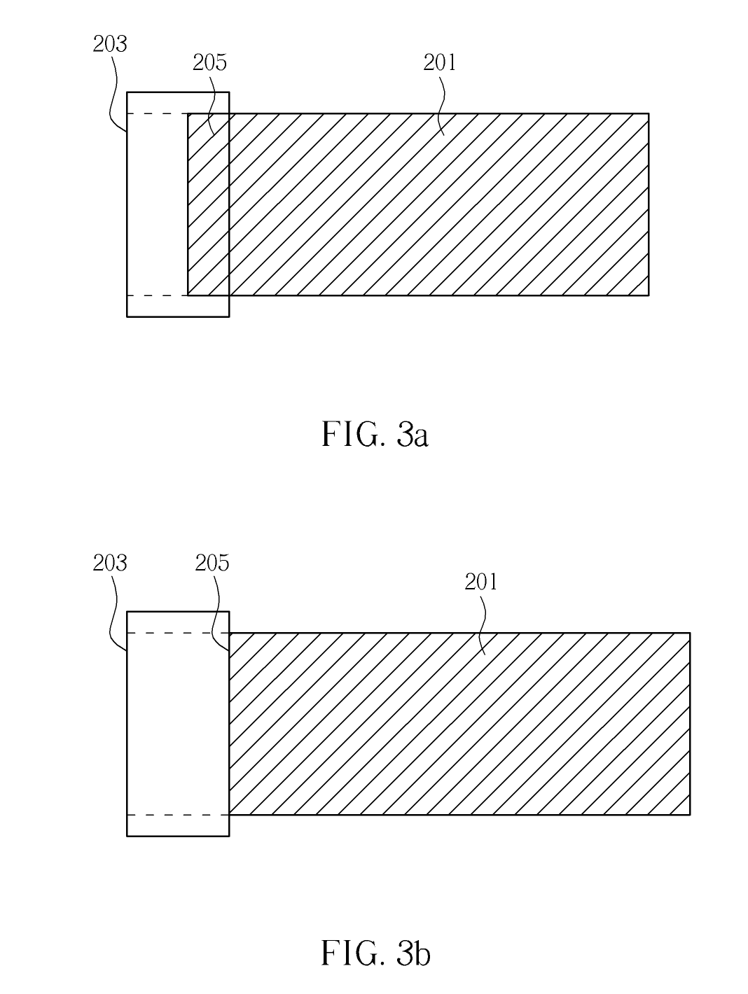

As shown in FIG. 2, the light pipe 200 includes a solid light guiding portion 201 and a hollow light guiding portion 203. Also, a length of the solid light guiding portion 201 is larger than which of the hollow light guiding portion 203. Besides, as shown in FIG. 3a, a cross-section area of the solid light guiding portion 201 at a combination part 205 is smaller than which of the hollow light guiding portion 203. Since an internal part of the hollow light guiding portion 203 is hollow, one combination structure of the solid light guiding portion 201 and the hollow light guiding portion 203 is as shown in FIG. 3a. That is, the solid light guiding portion 201 is socketed into the hollow light guiding portion 203, but it does not mean to limit the scope of the present invention. The embodiment shown in FIG. 2 can also be varied such that the solid light guiding portion 201 is only assembled with the hollow light guiding portion 203 but the solid light guiding portion 201 is not socked into the hollow light guiding portion 203, as shown in FIG. 3b. In this embodiment, the ratio between the lengths of the solid light guiding portion 201 and the hollow light guiding portion 203 determines a scaling ratio of an image. Besides, the scaling ratio is also related with a structure of the projecting apparatus, such that the ratio between the lengths of the solid light guiding portion 201 and the hollow light guiding portion 203 can be adjusted, thereby the light pipe 200 can match up the projecting apparatus to determine the image scaling ratio. In one embodiment, a length of the hollow light guiding portion 203 is not less than 5 mm (including no overlapping part of the solid light guiding portion 201), such that light can be reflected for enough numbers to be transmitted. In one embodiment, the length must be long enough for light to be reflected for more than three times.

The embodiment shown in FIG. 2 is utilized to explain the operation of the light pipes according to embodiments of the present invention. Please note that it does not mean to the operation is not limited to the embodiment shown in FIG. 2 but also can be applied to other embodiments. The solid light guiding portion 201 includes a receiving end 202 and an output end 204. The light beam enters the receiving end 202, and transmits the light beam to the output end via total reflection. The hollow light guiding portion 203 includes a hollow output end 206. The hollow light guiding portion 203 is combined with the output end 204 of the solid light guiding portion 201 in a combination part 205 shown in FIGS. 3a, 3b. The hollow light guiding portion 203 receives the light beam from the output end 204, and transmits the light beam to the hollow output end 206 via total reflection.

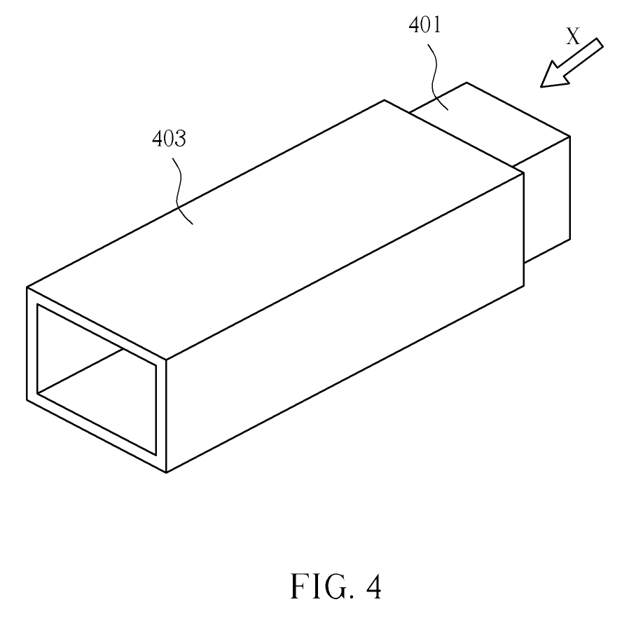

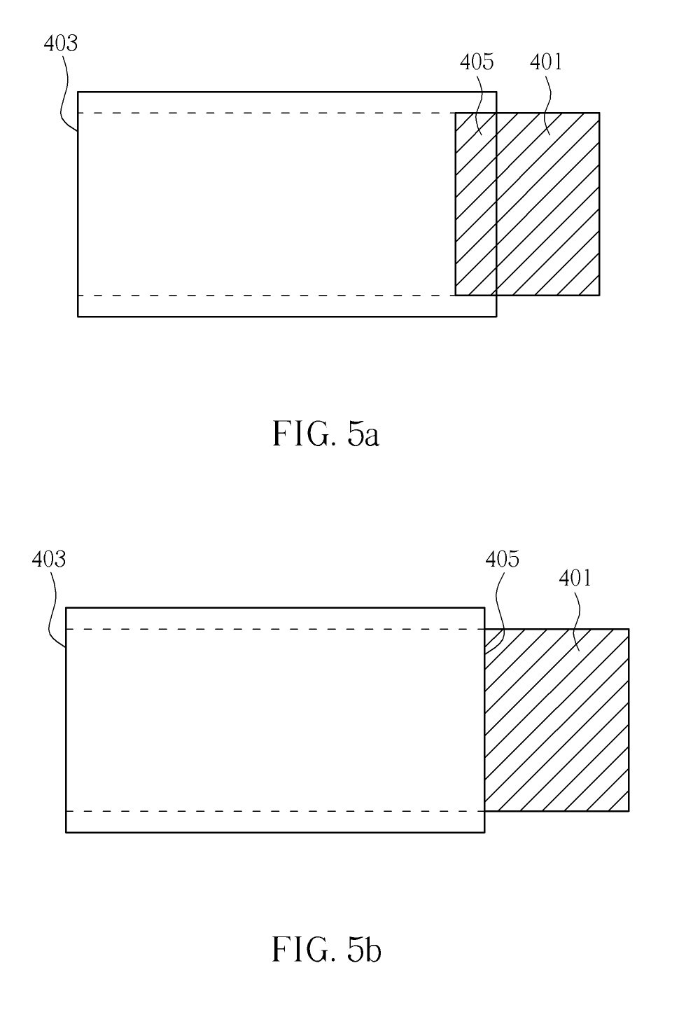

In the embodiment shown in FIG. 4, the light pipe 400 also includes a solid light guiding portion 401 and a hollow light guiding portion 403, and the length of the solid light guiding portion 401 is smaller than which of the hollow light guiding portion 403. Additionally, in the embodiment shown in FIG. 5a, a cross-section area of the solid light guiding portion 401 at a combination part 405 is smaller than which of the hollow light guiding portion 403. Similar with the structure shown in FIG. 3, since an internal part of the hollow light guiding portion 403 is hollow, one combination structure of the solid light guiding portion 401 and the hollow light guiding portion 403 is as shown in FIG. 5a. That is, the solid light guiding portion 401 is socketed into the hollow light guiding portion 403, but it does not mean to limit the scope of the present invention. The embodiment shown in FIG. 4 can also be varied such that the solid light guiding portion 401 is only assembled with the hollow light guiding portion 403 but the solid light guiding portion 201 is not socked into the hollow light guiding portion 403, as shown in FIG. 5b.

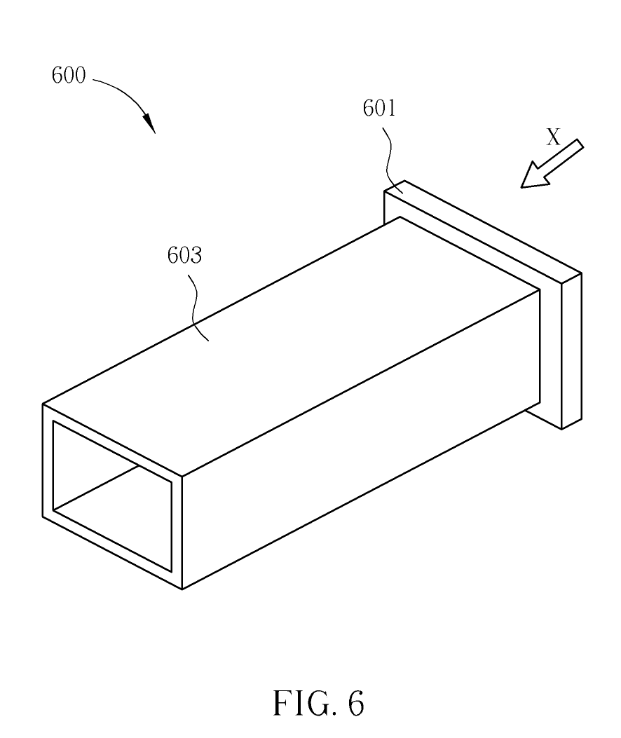

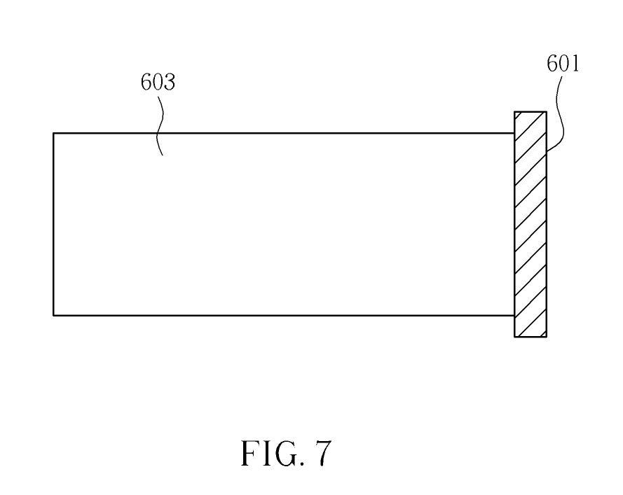

In the embodiment shown in FIG. 6, the light pipe 600 also includes a solid light guiding portion 601 and a hollow light guiding portion 603. Also, a length of the solid light guiding portion 601 is smaller than which of the hollow light guiding portion 603. As shown in FIG. 7, a cross-section area of the solid light guiding portion 601 at a combination part is larger than which of the hollow light guiding portion 603. Accordingly, the solid light guiding portion 601 can only be assembled with the hollow light guiding portion 603 but can not be socked into the hollow light guiding portion 603.

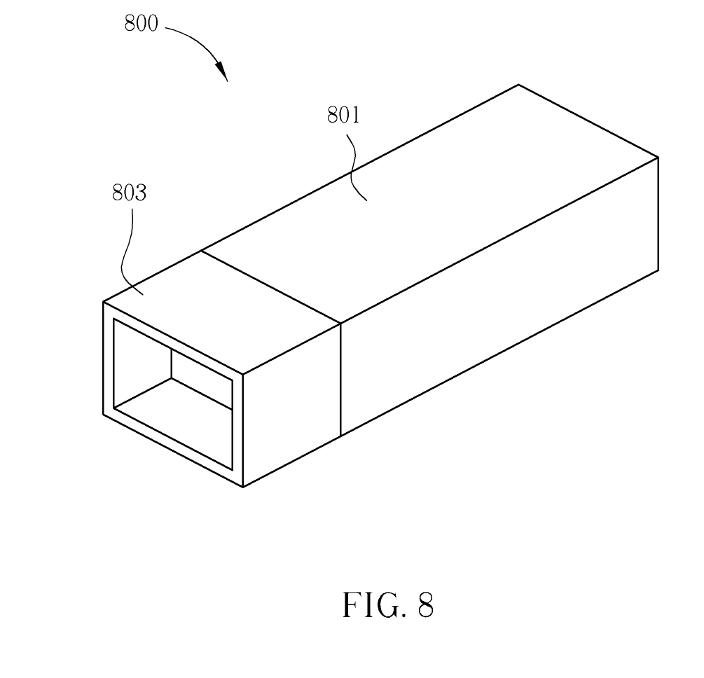

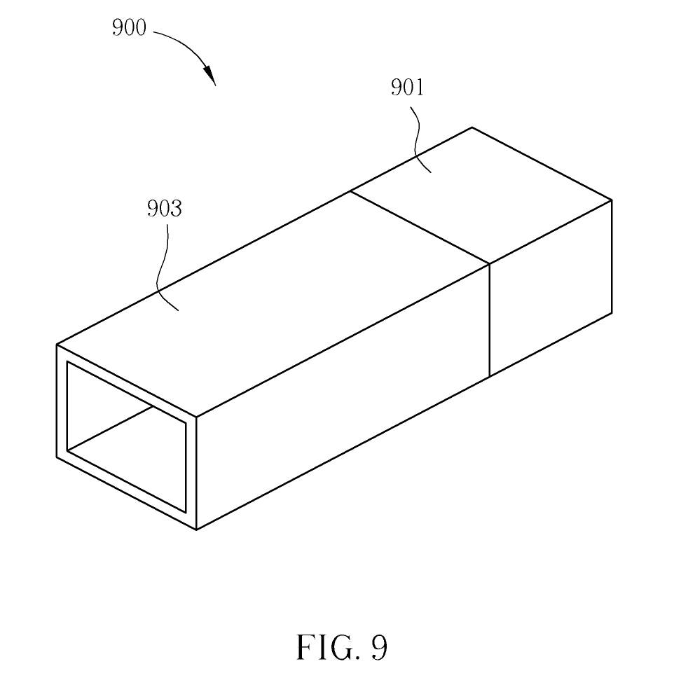

The above-mentioned embodiments disclose the structures that the solid light guiding portion and the hollow light guiding portion have different cross-section areas. However, the light pipe according to the present invention can have the solid light guiding portion and the hollow light guiding portion with the same cross-section areas, as shown in FIG. 8 and FIG. 9. FIG. 8 illustrates an embodiment that a length of the solid light guiding portion 801 is larger than which of the hollow light guiding portion 803. FIG. 9 illustrates an embodiment that a length of the solid light guiding portion 901 is smaller than which of the hollow light guiding portion 903. It should be noted that the lengths of the solid light guiding portion and the hollow light guiding portion should be long enough for light total reflection.

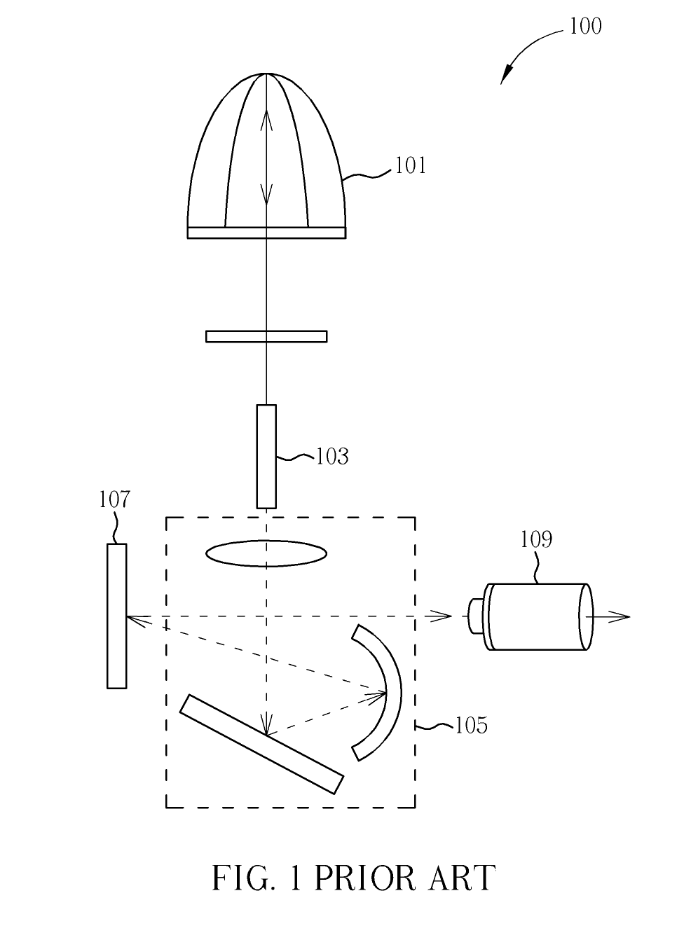

The light pipes disclosed in the above-mentioned embodiments can be applied to the projecting apparatus 100 in FIG. 1, but also can be applied to a projecting apparatus of other structures. If the light pipes of the present invention are applied to the projecting apparatus 100 shown in FIG. 1, light from the hollow light guiding portion is directly output to the image generator.

According to above mentioned embodiment, since a light incidence direction is toward the solid light guiding portion, dust can be protected from entering the hollow light guiding portion. Besides, a ratio between the hollow light guiding portion and the solid light guiding portion of the present invention can be adjusted. Accordingly, the ratio of the hollow light guiding portion can be increased if less cost is desired, and the ratio of the solid light guiding portion can be increased if higher efficiency is desired.

Those skilled in the art will readily observe that numerous modifications and alterations of the device and method may be made while retaining the teachings of the invention.

What is claimed is:

1. A light pipe, comprising:
a solid light guiding portion, including a receiving end and an output end, for receiving a light beam at the receiving end, and for transmitting the light beam to the output end via total reflection; and
a hollow light guiding portion, including a hollow output end, wherein the hollow light guiding portion is combined with the output end of the solid light guiding portion in a combination part, where the hollow light guiding portion receives the light beam from the output end, and transmits the light beam to the hollow output end via total reflection.

2. The light pipe of claim 1, wherein the hollow output end is not combined with another solid light guiding portion.

3. The light pipe of claim 1, wherein a cross-section area of the solid light guiding portion at the combination part is smaller than which of the hollow light guiding portion.

4. The light pipe of claim 3, wherein a length of the solid light guiding portion is larger than which of the hollow light guiding portion.

5. The light pipe of claim 4, wherein the length of the hollow light guiding portion is for light to reflect more than two times in the hollow light guiding portion.

6. The light pipe of claim 3, wherein a length of the solid light guiding portion is smaller than which of the hollow guiding portion.

7. The light pipe of claim 1, wherein a cross-section area of the solid light guiding portion at the combination part is larger than which of the hollow light guiding portion.

8. The light pipe of claim 7, wherein a length of the solid light guiding portion is smaller than which of the hollow guiding portion.

9. The light pipe of claim 1, wherein a cross-section area of the solid light guiding portion at the combination part equals to which of the hollow light guiding portion.

10. A projecting apparatus, comprising:
a light source module, for generating a light beam;
a light pipe, comprising:
a solid light guiding portion, including a receiving end and an output end, for receiving a light beam at the receiving end, and for transmitting the light beam to the output end via total reflection; and
a hollow light guiding portion, including a hollow output end, wherein the hollow light guiding portion is combined with the output end of the solid light guiding portion in a combination part, where the hollow light guiding portion receives the light beam from the output end, and transmits the light beam to the hollow output end via total reflection; and
a image generator, for receiving the light beam from the hollow light guiding portion to generate an image.

11. The projecting apparatus of claim 10, wherein the image generator directly receives the light beam from the hollow light guiding portion.

12. The projecting apparatus of claim 10, wherein the light source module includes a focusing light source module.

13. The projecting apparatus of claim 10, wherein a cross-section area of the solid light guiding portion at the combination part is smaller than which of the hollow light guiding portion.

14. The projecting apparatus of claim 13, wherein a length of the solid light guiding portion is larger than which of the hollow light guiding portion.

15. The projecting apparatus of claim 14, wherein the length of the hollow light guiding portion is long enough for light to reflect for more than two times in the hollow light guiding portion.

16. The projecting apparatus of claim 13, wherein a length of the solid light guiding portion is smaller than which of the hollow guiding portion.

17. The projecting apparatus of claim 10, wherein a cross-section area of the solid light guiding portion at the combination part is larger than which of the hollow light guiding portion.

18. The projecting apparatus of claim 17, wherein a length of the solid light guiding portion is smaller than which of the hollow guiding portion.

19. The projecting apparatus of claim 10, wherein a cross-section area of the solid light guiding portion at the combination part equals to which of the hollow light guiding portion.
